(19) United States
(12) Patent Application Publication
(10) Pub. No.: US 2026/0134466 A1
(43) Pub. Date: May 14, 2026

(54) VEHICLE SALES SYSTEM, IN-VEHICLE DEVICE, AND VEHICLE-SALES MANAGEMENT METHOD

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(72) Inventors: Kentarou TAKAKI, Osaka-shi, Osaka (JP); Junji YANO, Osaka-shi, Osaka (JP); Isao WATANABE, Toyota-shi, Aichi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(21) Appl. No.: 19/119,109

(22) PCT Filed: Aug. 31, 2023
(86) PCT No.: PCT/JP2023/031918

§ 371 Date: Apr. 8, 2025

(30) Foreign Application Priority Data
Oct. 11, 2022 (JP) 2022-163476

(51) Int. Cl. G06Q 30/0601; G07C 5/08

(52) U.S. Cl. CPC G06Q 30/0625; G07C 5/0841

(57) ABSTRACT

A vehicle sales system includes: a first management device being a management device and being configured to receive, from a vehicle, vehicle information including at least one of a list of vehicle components mounted on the vehicle, manufacturers of the vehicle components, a maintenance place for the vehicle, and use histories of the vehicle components, and to register, into a first database, first resale information generated based on the vehicle information having been received; and an output unit configured to acquire, from the first database, the first resale information corresponding to the vehicle, and to perform an output process based on the first resale information having been acquired.

### TECHNICAL FIELD

The present disclosure relates to a vehicle sales system, an in-vehicle device, and a vehicle-sales management method.

This application claims priority on Japanese Patent Application No. 2022-163476 filed on Oct. 11, 2022, the entire content of which is incorporated herein by reference.

### BACKGROUND ART

Japanese Laid-Open Patent Publication No. 2002-366829 (PATENT LITERATURE 1) discloses a method as below. That is, a method for providing value information for evaluating the post-use value of a vehicle, by using an in-vehicle device that is mounted on the vehicle and that detects the traveling state of the vehicle is disclosed. The method includes: a step of collecting travel data indicating the traveling state of the vehicle detected by the in-vehicle device; a step of obtaining driving status data corresponding to a past driving status of the vehicle, based on the collected travel data; a step of obtaining value information for evaluating the post-use value of the vehicle, based on the obtained driving status data; and a step of providing the obtained value information to a person to whom the information is to be provided.

### CITATION LIST

### Patent Literature

PATENT LITERATURE 1: Japanese Laid-Open Patent Publication No. 2002-366829
PATENT LITERATURE 2: Japanese Laid-Open Patent Publication No. 2002-259753
PATENT LITERATURE 3: Japanese Laid-Open Patent Publication No. 2015-141600

### SUMMARY OF THE INVENTION

A vehicle sales system of the present disclosure includes: a first management device being a management device used by an OEM, the first management device being configured to receive, from a vehicle, vehicle information including at least one of a list of vehicle components mounted on the vehicle, manufacturers of the vehicle components, a maintenance place for the vehicle, and use histories of the vehicle components, and to register, into a first database, first resale information generated based on the vehicle information having been received; and an output unit configured to acquire, from the first database, the first resale information corresponding to the vehicle, and to perform an output process based on the first resale information having been acquired.

An aspect of the present disclosure can be realized as a vehicle sales system including such a characteristic processing unit, but also as a program for causing a computer to execute steps of such characteristic processing. An aspect of the present disclosure can be realized as a semiconductor integrated circuit that realizes a part or the entirety of the vehicle sales system.

An aspect of the present disclosure can be realized as an in-vehicle device including such a characteristic processing unit, but also as a method having steps of such characteristic processing or as a program for causing a computer to execute such steps. An aspect of the present disclosure can be realized as a semiconductor integrated circuit that realizes a part or the entirety of the in-vehicle device.

An aspect of the present disclosure can be realized as a vehicle sales system including such a characteristic processing unit but also as a semiconductor integrated circuit that realizes a part or the entirety of the vehicle sales system.

### BRIEF DESCRIPTION OF DRAWINGS

FIG. 1 shows a configuration of a vehicle sales system according to an embodiment of the present disclosure.

FIG. 2 shows a configuration of an in-vehicle device according to the embodiment of the present disclosure.

FIG. 3 shows an example of a vehicle information accumulation DB in the vehicle sales system according to the embodiment of the present disclosure.

FIG. 4 shows another example of the vehicle information accumulation DB in the vehicle sales system according to the embodiment of the present disclosure.

FIG. 5 shows an example of a resale specification DB in the vehicle sales system according to the embodiment of the present disclosure.

FIG. 6 shows an example of a commodity DB in the vehicle sales system according to the embodiment of the present disclosure.

FIG. 7 shows an example of a search screen displayed by a used car sales company server according to the embodiment of the present disclosure.

FIG. 8 shows an example of a viewing screen displayed by the used car sales company server according to the embodiment of the present disclosure.

FIG. 9 shows an example of the sequence of a process regarding used car sales in the vehicle sales system according to the embodiment of the present disclosure.

FIG. 10 shows an example of a search screen displayed by an OEM server in a modification of the vehicle sales system according to the embodiment of the present disclosure.

FIG. 11 shows an example of a viewing screen displayed by the OEM server in the modification of the vehicle sales system according to the embodiment of the present disclosure.

FIG. 12 shows an example of the sequence of a process regarding used car sales in the modification of the vehicle sales system according to the embodiment of the present disclosure.

### DETAILED DESCRIPTION

To date, technologies for performing evaluation of vehicles in used car sales have been developed.

### Problems to be Solved by the Present Disclosure

In used car sales, a transaction is performed between an owner of a vehicle, an intermediary for the vehicle, and a purchaser of the vehicle. In such a transaction, a technology that can construct a better market environment involving an OEM (Original Equipment Manufacturer) is desired.

The present disclosure has been made in order to solve the above-described problem. An object of the present disclosure is to provide a vehicle sales system, an in-vehicle device, and a vehicle-sales management method that can construct a better market environment involving an OEM in a used car sales market.

### Effects of the Present Disclosure

According to the present disclosure, a better market environment involving the OEM can be constructed in the used car sales market.

### Description of Embodiment of the Present Disclosure

First, contents of the embodiment of the present disclosure are listed and described.

(1) A vehicle sales system according to an embodiment of the present disclosure includes: a first management device being a management device used by an OEM, the first management device being configured to receive, from a vehicle, vehicle information including at least one of a list of vehicle components mounted on the vehicle, manufacturers of the vehicle components, a maintenance place for the vehicle, and use histories of the vehicle components, and to register, into a first database, first resale information generated based on the vehicle information having been received; and an output unit configured to acquire, from the first database, the first resale information corresponding to the vehicle, and to perform an output process based on the first resale information having been acquired.

As described above, the first management device used by the OEM generates information, based on the vehicle information including at least one of the above pieces of information, and the output unit performs the output process based on the generated information. In this configuration, detailed and highly reliable information held by the OEM can be provided to the used car sales market. Accordingly, vehicle sales are promoted, and the OEM can gain profits from the used car sales market. Therefore, a better market environment involving the OEM can be constructed in the used car sales market.

(2) In (1) above, the output unit may be a second management device used by an intermediary for the vehicle.

In this configuration, the intermediary for the vehicle can provide information held by the OEM to a vehicle purchaser, and thus can be differentiated from other companies. In addition, since business materials increase, an effect of increasing the number of sales of inventory vehicles can be expected.

(3) In (2) above, the second management device may register, into a second database, second resale information generated based on the first resale information acquired from the first database, and may perform, as the output process, a process of displaying a screen including the second resale information acquired from the second database.

In this configuration, a viewing screen regarding the vehicle based on information held by the OEM can be presented to the vehicle purchaser. Therefore, sales of inventory vehicles can be promoted.

(4) In (3) above, the screen may include at least one of pieces of information regarding the manufacturers of the vehicle components, wear statuses of the vehicle components, and the maintenance place for the vehicle.

In this configuration, information that is held by the OEM and that allows determination as to reliability of maintenance or deterioration of the vehicle can be presented to the vehicle purchaser. Therefore, risk in selection of the vehicle for the vehicle purchaser is reduced, and the superiority of the intermediary in the market can be improved.

(5) In (3) or (4) above, the second management device may perform a process of displaying the screen further including a price of the vehicle corresponding to the second resale information acquired from the second database.

In this configuration, detailed information held by the OEM can be presented to the vehicle purchaser together with the price of the vehicle. Therefore, the vehicle purchaser's sense of satisfaction with respect to the price of the vehicle can be improved.

(6) In any one of (3) to (5) above, the second management device may acquire, from the second database, the second resale information of the vehicle that meets a search condition, and display the second resale information on the screen, and the search condition may include at least one of a condition regarding a vehicle component mounted on the vehicle, and a condition regarding the maintenance place for the vehicle.

In this configuration, the vehicle purchaser can obtain information of the vehicle selected by using information that is held by the OEM and that allows determination as to reliability of maintenance or deterioration of the vehicle. Therefore, risk in selection of the vehicle is reduced, and the superiority of the intermediary in the market can be improved.

(7) In (1) above, the first management device may be the output unit, may acquire, from the first database, the first resale information of the vehicle that meets a search condition, and may perform, as the output process, a process of displaying a screen including the first resale information having been acquired.

In this configuration, the OEM can provide information held by itself to the intermediary for the vehicle, and thus, can be differentiated from others. In addition, since business materials increase, an effect of increasing the number of sales of inventory vehicles can be expected.

(8) In (7) above, the screen may include at least one of pieces of information regarding the manufacturers of the vehicle components, wear statuses of the vehicle components, and the maintenance place for the vehicle.

In this configuration, information that is held by the OEM and that allows determination as to reliability of maintenance or deterioration of the vehicle can be presented to the intermediary for the vehicle. Therefore, risk in selection of the vehicle for the intermediary is reduced, and the superiority of the OEM in the market can be improved.

(9) In (7) or (8) above, the search condition may include at least one of a condition regarding a vehicle component mounted on the vehicle, and a condition regarding the maintenance place for the vehicle.

In this configuration, the intermediary for the vehicle can obtain information of the vehicle selected by using information that is held by the OEM and that allows determination as to reliability of maintenance or deterioration of the vehicle. Therefore, risk in selection of the vehicle is reduced, and the superiority of the OEM in the market can be improved.

(10) An in-vehicle device according to the embodiment of the present disclosure includes: an acquisition unit configured to acquire vehicle information including at least one of a list of vehicle components mounted on a vehicle, manufacturers of the vehicle components, a maintenance place for the vehicle, and use histories of the vehicle components; and a communication unit configured to transmit the vehicle information acquired by the acquisition unit, to a management device used by an OEM.

As described above, the in-vehicle device transmits the vehicle information including at least one of the above pieces of information, to the management device used by the OEM. In this configuration, detailed and highly reliable information held by the OEM can be provided to the used car sales market via the management device. Accordingly, vehicle sales are promoted, and the OEM can gain profits from the used car sales market. Therefore, a better market environment involving the OEM can be constructed in the used car sales market.

(11) A vehicle-sales management method according to the embodiment of the present disclosure is performed in a vehicle sales system including a first management device used by an OEM. The vehicle-sales management method includes: a step of receiving, performed by the first management device, from a vehicle, vehicle information including at least one of a list of vehicle components mounted on the vehicle, manufacturers of the vehicle components, a maintenance place for the vehicle, and use histories of the vehicle components; a step of registering, performed by the first management device, into a first database, first resale information generated based on the vehicle information having been received; and a step of acquiring, from the first database, the first resale information corresponding to the vehicle, and of performing an output process based on the first resale information having been acquired.

As described above, the first management device used by the OEM generates information, based on the vehicle information including at least one of the above pieces of information, and the output unit performs the output process based on the generated information. In this configuration, detailed and highly reliable information held by the OEM can be provided to the used car sales market. Accordingly, vehicle sales are promoted, and the OEM can gain profits from the used car sales market. Therefore, a better market environment involving the OEM can be constructed in the used car sales market.

Hereinafter, an embodiment of the present disclosure will be described with reference to the drawings. In the drawings, the same or corresponding parts are denoted by the same reference signs, and descriptions thereof are not repeated. At least some parts of the embodiment described below can be combined together as desired.

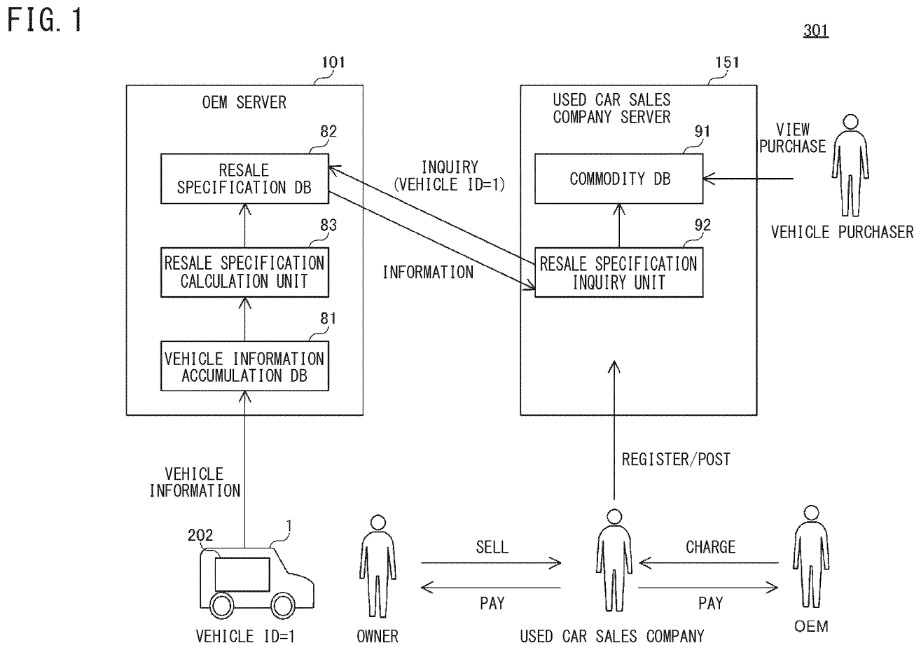

FIG. 1 shows a configuration of a vehicle sales system according to an embodiment of the present disclosure. With reference to FIG. 1, a vehicle sales system 301 includes an OEM server 101, a used car sales company server 151, and one or a plurality of in-vehicle devices 202. The OEM server 101 includes a vehicle information accumulation DB (database) 81, a resale specification DB 82, and a resale specification calculation unit 83. The used car sales company server 151 includes a commodity DB 91 and a resale specification inquiry unit 92. The OEM server 101, the used car sales company server 151, and the in-vehicle device 202 can perform transmission and reception of information with each other via a network such as the Internet, for example. The in-vehicle device 202 is mounted on a vehicle 1.

The OEM server 101 is an example of a first management device and is used by the OEM. The used car sales company server 151 is an example of a second management device, and is used by a used car sales company, which is an example of an intermediary for vehicles.

The OEM server 101 collects, from one or a plurality of the in-vehicle devices 202, vehicle information regarding a vehicle 1 corresponding thereto. More specifically, the OEM server 101 receives, from the vehicle 1, vehicle information including at least one of a list of vehicle components mounted on the vehicle 1, manufacturers of the vehicle components, the maintenance place for the vehicle 1, and use histories of the vehicle components. The OEM server 101 registers the collected vehicle information into the vehicle information accumulation DB 81.

The OEM server 101 generates first resale information, based on the vehicle information in the vehicle information accumulation DB 81, and registers the generated first resale information into the resale specification DB 82.

The vehicle sales system 301 includes an output unit that acquires, from the resale specification DB 82, first resale information corresponding to the vehicle 1 and that performs an output process based on the acquired first resale information.

The used car sales company server 151 is an example of the output unit, and transmits an inquiry indicating, for example, vehicle ID “1” to the resale specification DB 82 in the OEM server 101, thereby acquiring first resale information corresponding to vehicle ID “1” from the resale specification DB 82.

Then, the used car sales company server 151 generates second resale information, based on the first resale information acquired from the resale specification DB 82, and registers the generated second resale information into the commodity DB 91.

For example, the used car sales company server 151 performs, as the output process, a process of displaying a screen including the second resale information acquired from the commodity DB 91. For example, the screen includes at least one of pieces of information regarding manufacturers of vehicle components, wear statuses of vehicle components, and the maintenance place for the vehicle 1.

In such a vehicle sales system 301, the owner, i.e., the current owner, of the vehicle 1 sells the vehicle 1 having vehicle ID “1” of the owner, to a used car sales company, and the used car sales company pays a monetary amount to the owner. The used car sales company registers information such as the vehicle ID, the vehicle model, and the model year of the purchased vehicle 1 into the commodity DB 91, thereby posting the information on a website of the company. A vehicle purchaser accesses the used car sales company server 151 to view the above screen including the information, and determines whether to purchase the vehicle 1. The OEM charges a monetary amount in exchange for the provision of the first resale information in the resale specification DB 82 to the used car sales company, and the used car sales company pays the monetary amount to the OEM.

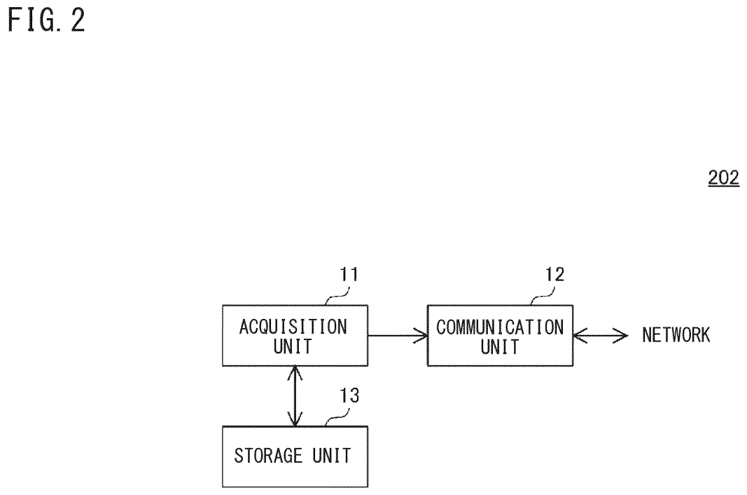

FIG. 2 shows a configuration of the in-vehicle device according to the embodiment of the present disclosure. With reference to FIG. 2, the in-vehicle device 202 includes an acquisition unit 11, a communication unit 12, and a storage unit 13. One or both of the acquisition unit 11 and the communication unit 12 are realized by processing circuitry including one or a plurality of processors, for example. The storage unit 13 is a nonvolatile memory included in the above processing circuitry, for example.

The acquisition unit 11 acquires vehicle information including at least one of a list of vehicle components mounted on the vehicle 1, manufacturers of the vehicle components, the maintenance place for the vehicle 1 such as the replacement place of the vehicle components, and use histories of the vehicle components, from, for example, the storage unit 13 or another in-vehicle instrument mounted on the vehicle 1, and outputs the vehicle information to the communication unit 12. Based on the information on the maintenance place, it is possible to determine whether the vehicle 1 was subjected to maintenance at an authorized dealer, or at another place, for example.

The vehicle information is not limited to the above. The vehicle information may include position information of the vehicle 1, may include internal vehicle information exchanged inside the vehicle 1, or may include data occurrence time, for example. The internal vehicle information is a measurement result from a sensor mounted on the vehicle 1, such as a vehicle speed or a voltage of a battery, or driving control information such as a brake operation in the vehicle 1, for example. The vehicle information may be a combination of various types of information including the above information. The in-vehicle device 202 may be configured to transmit, to the OEM server 101, probe data including the position information and including other vehicle information.

The communication unit 12 performs transmission and reception of information to and from the OEM server 101 via a network. The communication unit 12 transmits, to the OEM server 101, vehicle information, regarding the vehicle 1, that is information including identification information of the vehicle 1. More specifically, for example, the communication unit 12 attaches the vehicle ID of the vehicle 1 to the vehicle information received from the acquisition unit 11, and transmits the resultant vehicle information to the OEM server 101 via the network.

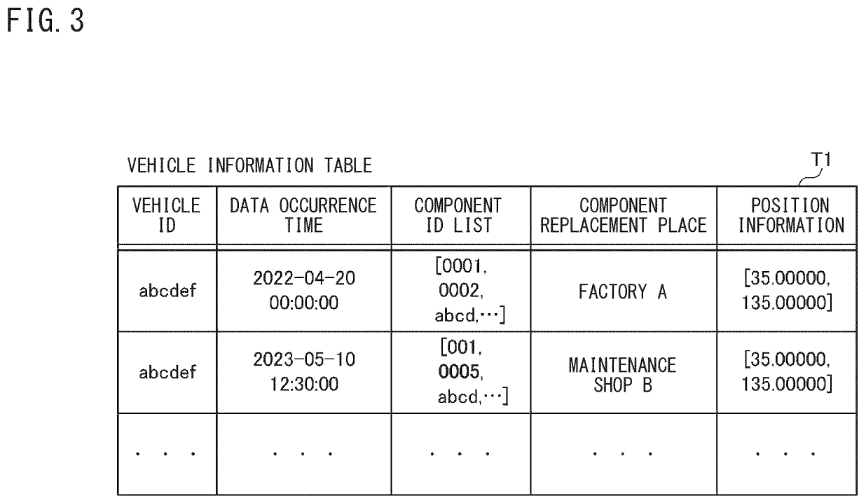

FIG. 3 shows an example of the vehicle information accumulation DB in the vehicle sales system according to the embodiment of the present disclosure.

With reference to FIG. 3, the vehicle information accumulation DB 81 includes a vehicle information table T1. The vehicle information table T1 includes a vehicle ID, a data occurrence time, a component ID list being a list of vehicle components, a component replacement place, and position information, for each piece of vehicle information.

In the example of the vehicle information table T1 shown in FIG. 3, with respect to a vehicle 1 having vehicle ID “abcdef”, it is recorded that vehicle components were replaced at factory A on Apr. 20, 2022, and then, a vehicle component having component ID “0002” was replaced by a vehicle component having component ID “0005” at maintenance shop B on May 10, 2023. Based on the component ID, it is possible to identify whether the corresponding vehicle component is an authorized article or a component provided by a third party, for example.

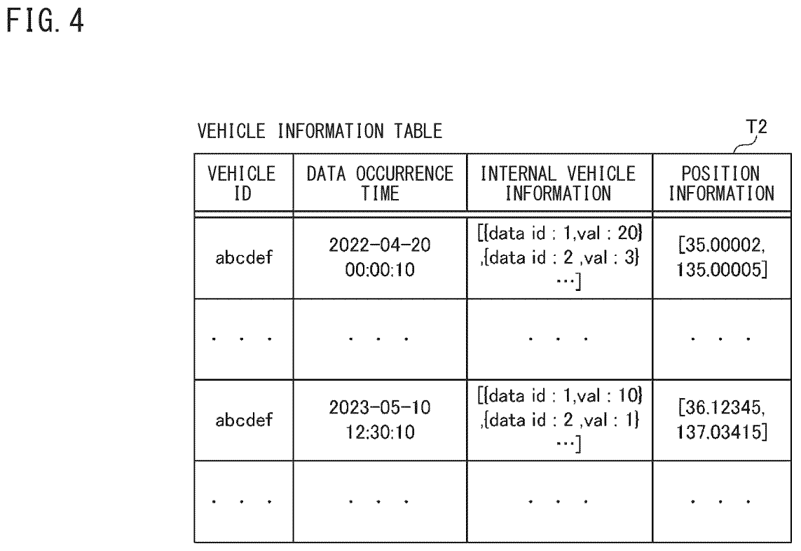

FIG. 4 shows another example of the vehicle information accumulation DB in the vehicle sales system according to the embodiment of the present disclosure.

With reference to FIG. 4, the vehicle information accumulation DB 81 includes a vehicle information table T2. The vehicle information table T2 includes a vehicle ID, a data occurrence time, internal vehicle information, and position information, for each piece of vehicle information.

In the example of the vehicle information table T2 shown in FIG. 4, with respect to the vehicle 1 having vehicle ID “abcdef”, it is recorded that, on Apr. 20, 2022, vehicle information in which: the value of data ID “1” was 20: the value of data ID “2” was 3; and the latitude was 35.00002 degrees and the longitude was 135.00005 degrees in the position information, was transmitted. In addition, with respect to the same vehicle 1, it is recorded that, on May 10, 2023, vehicle information in which: the value of data ID “1” was 10; the value of data ID “2” was 1; and the latitude was 36.12345 degrees and the longitude was 137.03415 degrees in the position information, was transmitted.

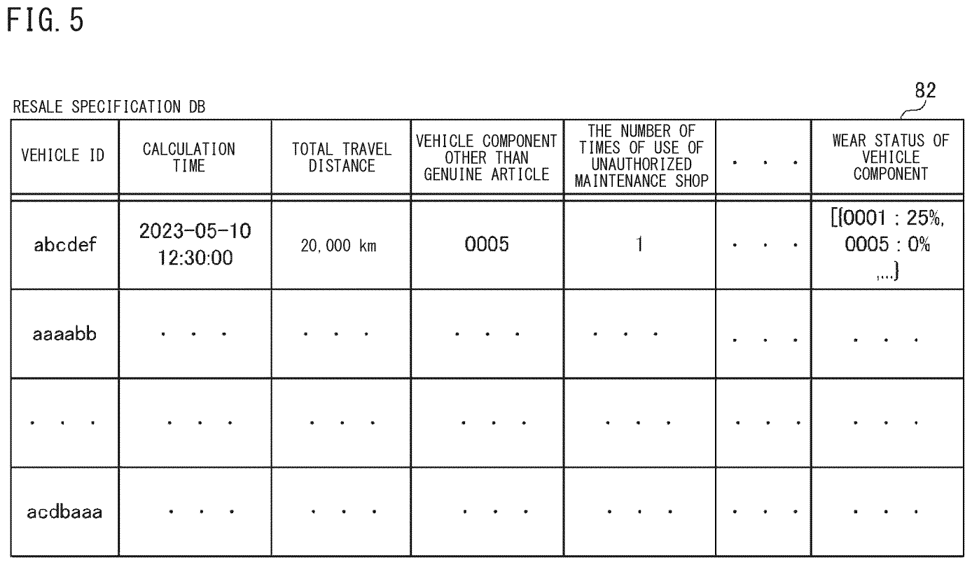

FIG. 5 shows an example of the resale specification DB in the vehicle sales system according to the embodiment of the present disclosure.

Based on the vehicle information in the vehicle information accumulation DB 81, the OEM server 101 generates first resale information being at least one of whether or not a vehicle component other than a genuine article is mounted, and a use history of an unauthorized maintenance shop, and registers the first resale information into the resale specification DB 82.

Specifically, with reference to FIG. 5, the resale specification DB 82 includes a vehicle ID, a resale specification being an example of the first resale information, and a calculation time of the resale specification, for each vehicle 1. In this example, the resale specification includes a total travel distance, a component ID of a vehicle component other than a genuine article, the number of times of use of an unauthorized maintenance shop, and wear statuses, i.e., the deterioration degree, of vehicle components.

The resale specification is information regarding a vehicle based on which a vehicle purchaser determines whether to purchase the vehicle, for example. In addition, the resale specification is information regarding a vehicle based on which a used car sales company determines the price of the vehicle, for example.

In the example shown in FIG. 5, in a vehicle 1 having vehicle ID “abcdef”, the total travel distance is 20,000 km, the component ID of a vehicle component other than a genuine article is “0005”, the number of times of use of an unauthorized maintenance shop is 1, the wear degree of a vehicle component having component ID “0001” is 25%, and the wear degree of a vehicle component having component ID “0005” is 0%.

The resale specification calculation unit 83 calculates the total travel distance according to formula (1) below, for example.

$$[ Math 1 ]$$

$${{{\sum }_{i = 2}^{N} ( \sqrt{( ( {x}_{i}} - {x}_{i - 1} ) \times 91 )}^{2} + \sqrt{( ( {y}_{i}} - {y}_{i - 1} ) \times 110 )}^{2} ) \qquad ( 1 )$$

Here, xk is the latitude, yk is the longitude, N is the number of records, “91” and “110” are values for performing approximate distance calculation between coordinates in Japan, and the unit is km. k is an integer from 2 to N.

The resale specification calculation unit 83 performs calculation for obtaining a vehicle component other than a genuine article according to formula (2) below, for example.

$$( Newest component ID list ) ⋂ ( complementary set of genuine article component list ) \qquad ( 2 )$$

The resale specification calculation unit 83 calculates the number of times of use of an unauthorized maintenance shop according to formula (3) below, for example. Here, n is the number of elements of the set.

$$n ( ( past component replacement place ) ⋂ ( complementary set of authorized component replacement place list ) ) \qquad ( 3 )$$

The resale specification calculation unit 83 calculates the wear status of a battery having component ID “0001” according to formula (4) below, for example. The discharge capacity of the battery is an example of use histories of vehicle components included in the vehicle information.

$$Wear status of a vehicle component = ( discharge capacity of the battery in the latest one month / rated capacity of the battery at the time of shipping ) \times 100 \qquad ( 4 )$$

The resale specification calculation unit 83 calculates the wear status of a tire having component ID “0005” according to formula (5) below, for example. The tire groove depth is an example of use histories of vehicle components included in the vehicle information.

$$Wear status of a vehicle component = ( latest tire groove depth / tire groove depth at the time of shipping ) \times 100 \qquad ( 5 )$$

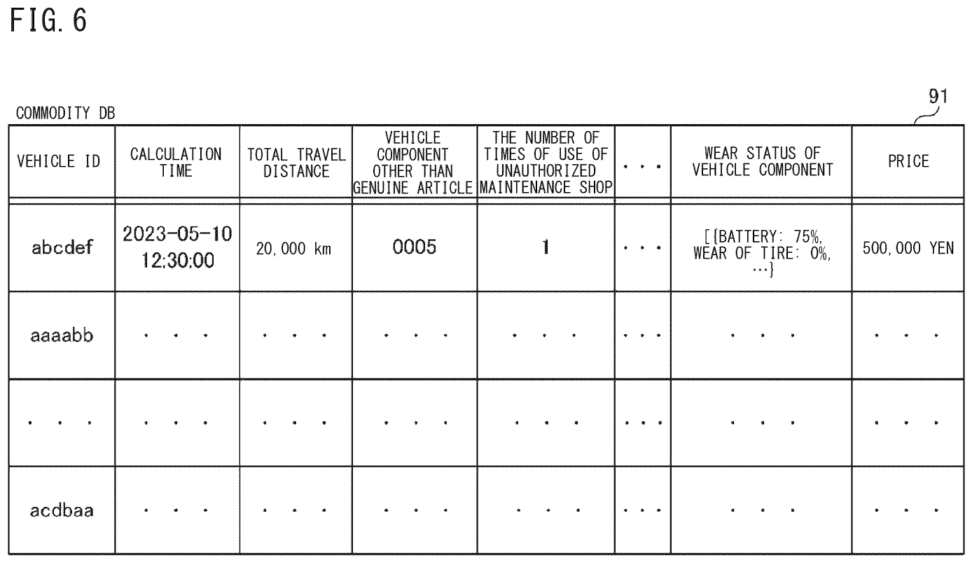

FIG. 6 shows an example of the commodity DB in the vehicle sales system according to the embodiment of the present disclosure.

With reference to FIG. 6, the commodity DB 91 includes a vehicle ID, a calculation time of the resale specification, a total travel distance, an ID of a vehicle component other than a genuine article, the number of times of use of an unauthorized maintenance shop, wear statuses of vehicle components, and a price, for each vehicle 1.

In the example shown in FIG. 6, in a vehicle 1 having vehicle ID “abcdef”, the total travel distance is 20,000 km, the component ID of a vehicle component other than a genuine article is “0005”, the number of times of use of an unauthorized maintenance shop is 1, the wear degree of a battery is 75%, the wear degree of a tire is 0%, and the price is 500,000 yen.

With respect to the wear status of each vehicle component read out from the resale specification DB 82, for example, the resale specification inquiry unit 92 changes the component ID to the name of a specific vehicle component. Specifically, for example, the resale specification inquiry unit 92 changes component ID “0001” to “battery”, changes component ID “0005” to “tire”, and registers the resultant information as the second resale information, into the commodity DB 91.

The price of the vehicle 1 is registered into the commodity DB 91 by the used car sales company having referred to the contents of the vehicle information of the commodity DB 91, for example. The used car sales company server 151 may be configured to calculate the price of the vehicle 1 and register the price into the commodity DB 91.

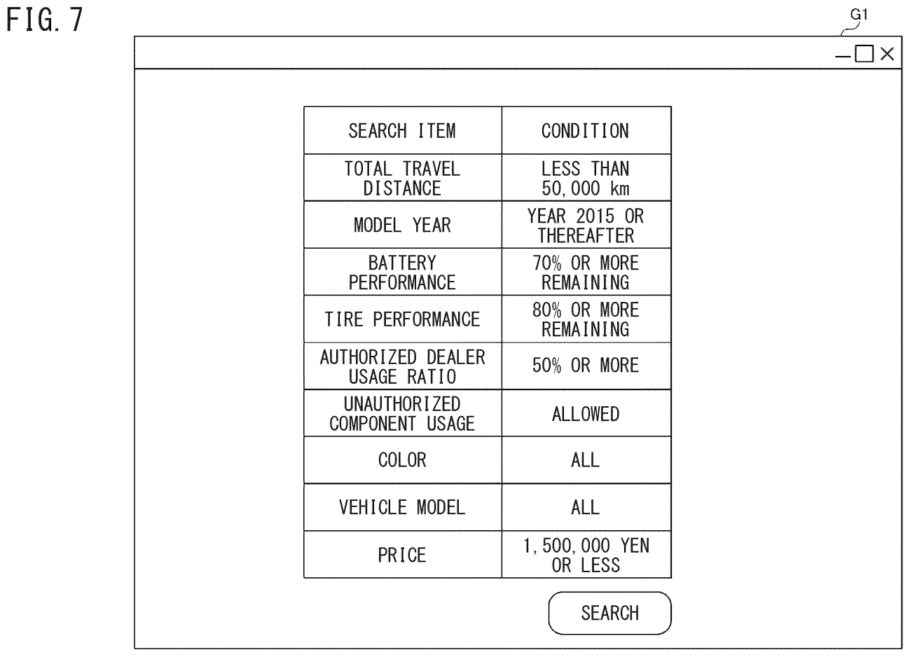

FIG. 7 shows an example of a search screen displayed by the used car sales company server according to the embodiment of the present disclosure.

With reference to FIG. 7, the used car sales company server 151 acquires, from the commodity DB 91, second resale information of the vehicle 1 that meets a search condition, and displays the second resale information on a screen. The search condition includes at least one of a condition regarding vehicle components mounted on the vehicle 1 and a condition regarding a maintenance place for the vehicle 1.

In the example shown in FIG. 7, the used car sales company server 151 displays a screen G1 for receiving an input of a search condition regarding the total travel distance, the model year, the battery performance, the tire performance, the authorized dealer usage ratio, the unauthorized component usage, the color, the vehicle model, and the price.

The vehicle purchaser inputs a search condition that: the total travel distance is less than 50,000 km; the model year is year 2015 or thereafter; the battery performance is 70% or more remaining, i.e., the wear degree is less than 30%; the tire performance is 80% or more remaining, i.e., the wear degree is less than 20%; the authorized dealer usage ratio is 50% or more; unauthorized component usage is allowed; the color is not designated; the vehicle model is not designated; and the price is 1,500,000 yen or less.

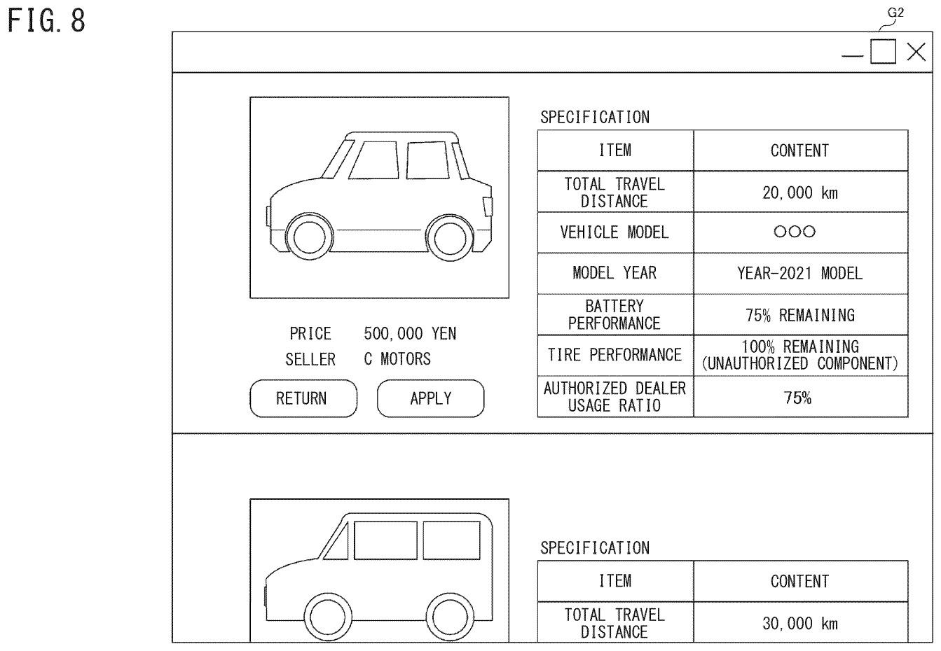

FIG. 8 shows an example of a viewing screen displayed by the used car sales company server according to the embodiment of the present disclosure.

With reference to FIG. 8, the used car sales company server 151 performs a process of displaying, as a viewing screen including second resale information acquired from the commodity DB 91, a screen further including the price of the vehicle 1 corresponding to the second resale information acquired from the commodity DB 91.

In the example shown in FIG. 8, the used car sales company server 151 displays a screen G2 showing: a photograph and the seller of a vehicle 1 that meets the search condition shown in FIG. 7; as the specification of the vehicle 1, that the total travel distance is 20,000 km, the vehicle model is ∘∘∘, the model year is 2021, the battery performance is 75% remaining, the tire performance is 100% remaining, the tire is an unauthorized component, and the authorized dealer usage ratio is 75%; and that the price is 500,000 yen. In the example shown in FIG. 8, a list of vehicles 1 that meet the search condition is displayed, and a part of information of another vehicle 1 that meets the search condition is displayed in a lower part of the screen G2.

### [Operation Flow]

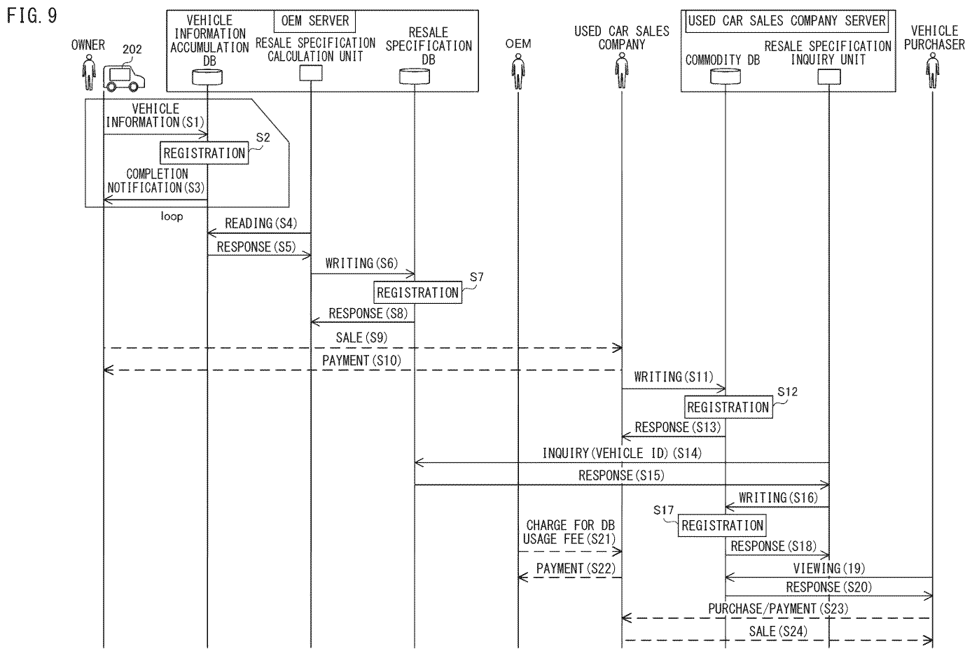

FIG. 9 shows an example of the sequence of a process regarding used car sales in the vehicle sales system according to the embodiment of the present disclosure. In FIG. 9, solid line arrows each indicate a flow of information, and dotted line arrows each indicate a flow of money or a vehicle.

With reference to FIG. 9, first, the in-vehicle device 202 in a vehicle 1 periodically or non-periodically transmits vehicle information to the OEM server 101 (step S1).

Next, the OEM server 101 registers the vehicle information received from the in-vehicle device 202 into the vehicle information accumulation DB 81 (step S2), and transmits a completion notification to the in-vehicle device 202 (step S3). Such exchange and registration of information are repeatedly performed.

Next, the resale specification calculation unit 83 periodically or non-periodically provides a reading command to the vehicle information accumulation DB 81 (step S4), and acquires vehicle information as a response (step S5).

Next, based on the acquired vehicle information, the resale specification calculation unit 83 calculates first resale information, e.g., the resale specification as described above, provides a writing command for writing the calculated resale specification, to the resale specification DB 82 (step S6), registers the resale specification (step S7), and receives a response from the resale specification DB 82 (step S8).

Next, the owner sells the vehicle 1 to the used car sales company (step S9) and receives payment from the used car sales company (step S10).

Next, the used car sales company provides a writing command for writing information such as the vehicle model and the model year of the purchased vehicle 1, to the commodity DB 91 (step S11), registers the information (step S12), and receives a response from the commodity DB 91 (step S13).

Next, the resale specification inquiry unit 92 monitors the commodity DB 91, provides, upon the information of the vehicle 1 being newly registered, an inquiry indicating the vehicle ID of the vehicle 1, to the resale specification DB 82 (step S14), and acquires the resale specification of the vehicle 1 as a response (step S15).

Next, based on the acquired resale specification, the resale specification inquiry unit 92 generates second resale information as described above, provides a writing command for writing the generated second resale information, to the commodity DB 91 (step S16), registers the second resale information (step S17), and receives a response from the commodity DB 91 (step S18).

Next, the vehicle purchaser provides a viewing command indicating a search condition as shown in FIG. 7, to the commodity DB 91 (step S19), and acquires information shown on the viewing screen regarding the vehicle 1 as shown in FIG. 8, as a response (step S20), for example.

Next, when the vehicle purchaser has decided to purchase the vehicle 1, the vehicle purchaser performs purchase of the vehicle 1 and payment of a monetary amount to the used car sales company (step S23). Then, the used car sales company sells the vehicle 1 to the vehicle purchaser (step S24).

The OEM charges the used car sales company for the usage fee of the resale specification DB 82 (step S21), and receives payment (step S21).

### Description of Problem

Between the three parties of the OEM, the vehicle purchaser, and the used car sales company, there is a problem as below. That is, the OEM is less likely to gain profits from the used car sales market. For example, it is difficult for the OEM to gain profits from used car business platforms outside the affiliated group. When a used car purchaser is to purchase a used car on a website, for example, the specification of a vehicle that can be confirmed is often limited to contents such as the model year, the travel distance, whether or not the automobile inspection is valid, and a repair history, and there is little information for determining the purchase. The used car sales company wants to increase business materials as much as possible. For example, even in a case of a vehicle that is not selling well, or the like, if the maintenance state or the like can be visualized, it will be easier to obtain a buyer.

With respect to such a problem, in the vehicle sales system according to the embodiment of the present disclosure, the above configuration allows the OEM to provide information based on the vehicle information to the used car sales company serving as a platform provider in the used car business, whereby vehicle sales are promoted, and a win-win relationship can be constructed.

That is, the OEM can gain profits from the used car sales market. The used car purchaser becomes able to know the detailed specification of the vehicle at the time of purchase, and the information for determination at the time of purchase can be increased. That is, due to the presence of additional information on the platform, risk in selection of the vehicle to be purchased is reduced, and the platform provider having the additional information gains an advantage in the market. For example, the used car sales company can be differentiated from websites of other companies. In addition, since business materials increase, an effect of increasing the number of sales of inventory vehicles can be expected.

### Modification

The OEM server 101 may be configured to acquire, as the output unit, first resale information of a vehicle 1 that meets the search condition, from the resale specification DB 82, and perform, as the output process, a process of displaying a screen including the acquired first resale information.

In this case, the vehicle sales system 301 may be configured not to include the used car sales company server 151.

An application example of the modification of the vehicle sales system 301 is as follows. That is, in recent years, there is a case where a vehicle is provided from the OEM to a consumer in a lease form. When the lease period has expired, the vehicle 1 is returned to the OEM. In the modification of the vehicle sales system 301, the state of such a returned vehicle 1 can be confirmed in the used car sales company. The used car sales company buys the vehicle 1 whose lease period has expired, from the OEM.

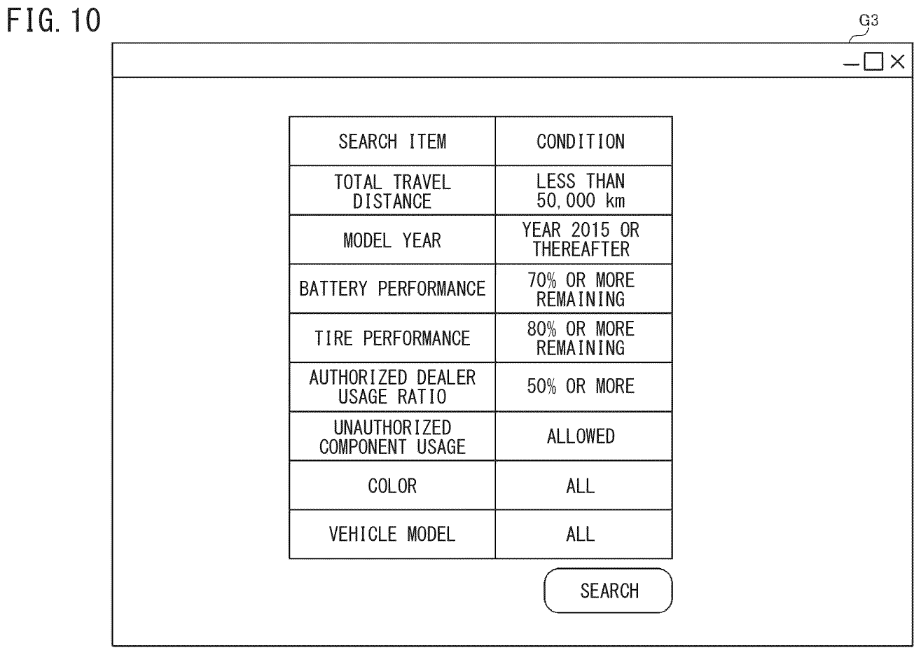

FIG. 10 shows an example of a search screen displayed by the OEM server in the modification of the vehicle sales system according to the embodiment of the present disclosure.

With reference to FIG. 10, the search condition includes at least one of a condition regarding vehicle components mounted on the vehicle 1, and a condition regarding the maintenance place for the vehicle 1, for example. The OEM server 101 performs a process of displaying a screen for receiving an input of the search condition.

As compared with the screen G1 shown in FIG. 7, a screen G3 shown in FIG. 10 does not include information of the price, and the other information is the same.

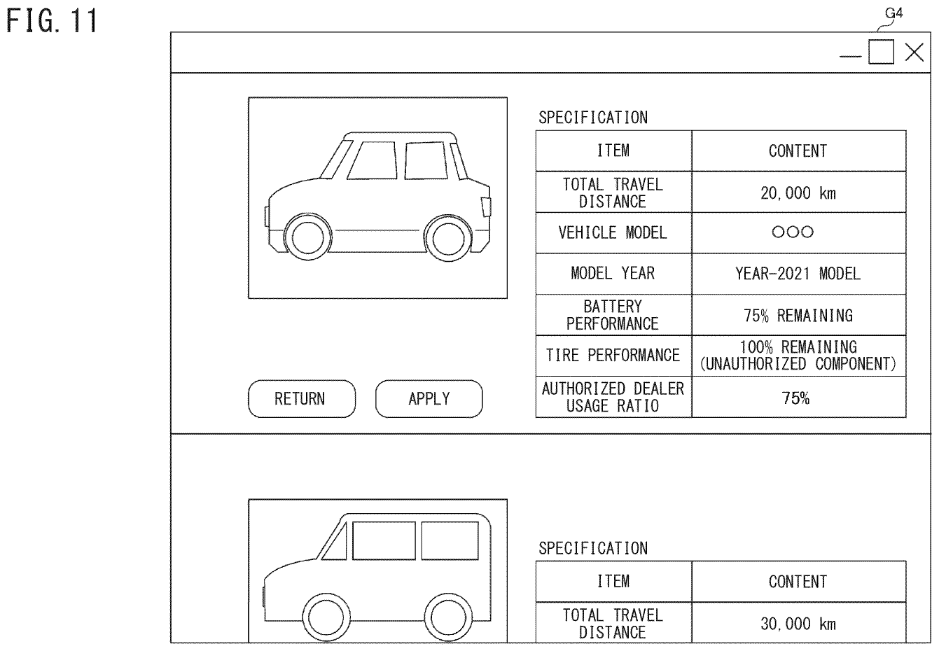

FIG. 11 shows an example of a viewing screen displayed by the OEM server in the modification of the vehicle sales system according to the embodiment of the present disclosure.

With reference to FIG. 11, the OEM server 101 performs a process of displaying a screen, as a viewing screen based on the resale specification acquired from the resale specification DB 82, that includes at least one of pieces of information regarding manufacturers of vehicle components, wear statuses of vehicle components, and the maintenance place for the vehicle 1, for example.

As compared with the screen G2 shown in FIG. 8, a screen G4 shown in FIG. 11 does not include the price and the seller of the vehicle 1, and the other information is the same.

In the above-described example in which the used car sales company server 151 serves as the output unit, the used car sales company may decide the price of the vehicle 1 as shown in FIG. 8 by referring to the screen G4.

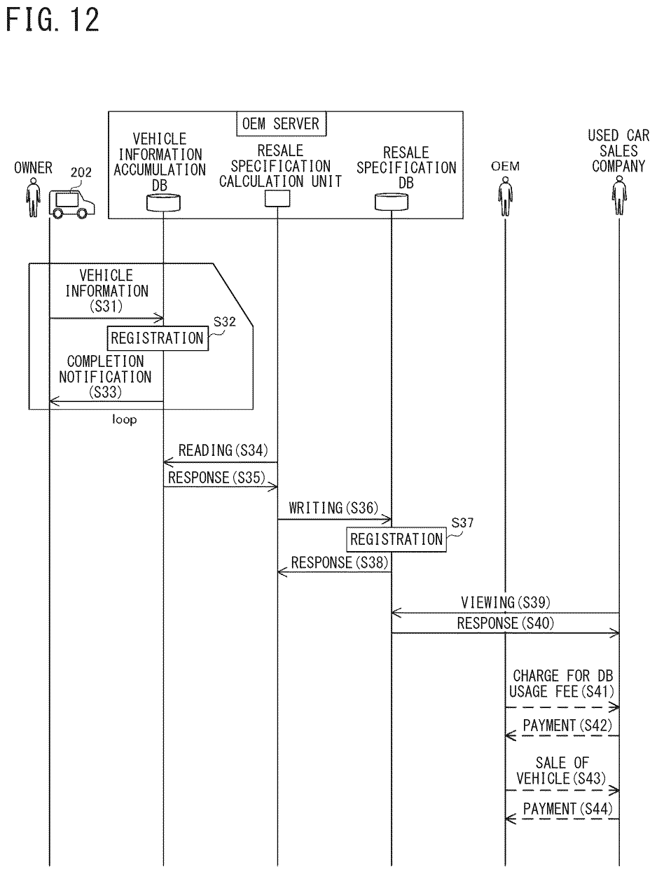

FIG. 12 shows an example of the sequence of a process regarding used car sales in the modification of the vehicle sales system according to the embodiment of the present disclosure. In FIG. 12, solid line arrows each indicate a flow of information, and dotted line arrows each indicate a flow of money or a vehicle.

With reference to FIG. 12, the processes in steps S31 to S38 are the same as the processes in steps S1 to S8 shown in FIG. 9.

Next, the used car sales company provides a viewing command indicating a search condition as shown in FIG. 10, to the resale specification DB 82 (step S39), and acquires information shown on the viewing screen regarding the vehicle 1 as shown in FIG. 11 as a response (step S40), for example.

Next, the OEM charges the used car sales company for the usage fee of the resale specification DB 82 (step S41), and receives payment (step S42).

Next, when the used car sales company has decided to purchase the vehicle 1, the OEM sells the vehicle 1 to the used car sales company (step S43), and receives payment from the used car sales company (step S44).

A part or all of the functions of each of the OEM server 101 and the used car sales company server 151 may be provided by cloud computing. That is, the OEM server 101 and the used car sales company server 151 according to the embodiment of the present disclosure may be a cloud server configured by a plurality of servers.

Each process (each function) of the embodiment described above is realized by processing circuitry including one or a plurality of processors. The above processing circuitry may be configured as an integrated circuit or the like in which one or a plurality of memories, various analog circuits, and various digital circuits are combined, in addition to the one or the plurality of processors. The one or the plurality of memories have stored herein a program (command) that causes the one or the plurality of processors to execute the above processes. The one or the plurality of processors may execute the above processes according to the program that is read from the one or the plurality of memories, or may execute the above processes according to a logic circuit that is designed in advance to execute the above processes. The processors may be various processors conforming to control of a computer, such as a CPU (Central Processing Unit), a GPU (Graphics Processing Unit), a DSP (Digital Signal Processor), an FPGA (Field Programmable Gate Array), and an ASIC (Application Specific Integrated Circuit). The plurality of processors physically separated from each other may execute the above processes in cooperation with each other. For example, the processors respectively installed in a plurality of physically separated computers may execute the above processes in cooperation with each other via a network such as a LAN (Local Area Network), a WAN (Wide Area Network), and the Internet. The program may be installed in the memories via the network from an external server device or the like, or may be distributed in a state of being stored in a storage medium such as a CD-ROM (Compact Disc Read Only Memory), a DVD-ROM (Digital Versatile Disk Read Only Memory), or a semiconductor memory, and may be installed in the memories from the storage medium.

The disclosed embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

### Additional Note 1

A vehicle sales system including a first management device used by an OEM, wherein
the first management device receives, from a vehicle, vehicle information including at least one of a list of vehicle components mounted on the vehicle, manufacturers of the vehicle components, a maintenance place for the vehicle, and use histories of the vehicle components, and registers, into a first database, first resale information generated based on the vehicle information having been received,
the vehicle sales system further includes
   an output unit configured to acquire, from the first database, the first resale information corresponding to the vehicle, and to perform an output process based on the first resale information having been acquired, and
the first management device receives the vehicle information from the vehicle, registers the vehicle information into a third database, generates, based on the vehicle information in the third database, the first resale information being at least one of whether or not a vehicle component other than a genuine article is mounted, and a use history of an unauthorized maintenance shop, and registers the first resale information into the first database.

### Additional Note 2

An in-vehicle device including:
an acquisition unit configured to acquire vehicle information including at least one of a list of vehicle components mounted on a vehicle, manufacturers of the vehicle components, a maintenance place for the vehicle, and use histories of the vehicle components; and
a communication unit configured to transmit the vehicle information acquired by the acquisition unit, to a management device used by an OEM, wherein
the vehicle information further includes at least one of position information of the vehicle, internal vehicle information exchanged inside the vehicle, and a data occurrence time.

### Additional Note 3

An in-vehicle device including processing circuitry, wherein
the processing circuitry
   acquires vehicle information including at least one of a list of vehicle components mounted on a vehicle, manufacturers of the vehicle components, a maintenance place for the vehicle, and use histories of the vehicle components, and
   transmits the vehicle information having been acquired to a management device used by an OEM.
1 vehicle
11 acquisition unit
12 communication unit
13 storage unit
81 vehicle information accumulation DB
82 resale specification DB
83 resale specification calculation unit
91 commodity DB
92 resale specification inquiry unit
101 OEM server
151 used car sales company server
202 in-vehicle device
301 vehicle sales system
G1, G2, G3, G4 screen
T1, T2 vehicle information table

1. A vehicle sales system comprising:
a first management device being a management device used by an OEM (Original Equipment Manufacturer), the first management device being configured to receive, from a vehicle, vehicle information including at least one of a list of vehicle components mounted on the vehicle, manufacturers of the vehicle components, a maintenance place for the vehicle, and use histories of the vehicle components, and to register, into a first database, first resale information generated based on the vehicle information having been received; and
an output device configured to acquire, from the first database, the first resale information corresponding to the vehicle, and to perform an output process based on the first resale information having been acquired.

2. The vehicle sales system according to claim 1, wherein
the output device is a second management device used by an intermediary for the vehicle.

3. The vehicle sales system according to claim 2, wherein
the second management device registers, into a second database, second resale information generated based on the first resale information acquired from the first database, and performs, as the output process, a process of displaying a screen including the second resale information acquired from the second database.

4. The vehicle sales system according to claim 3, wherein
the screen includes at least one of pieces of information regarding the manufacturers of the vehicle components, wear statuses of the vehicle components, and the maintenance place for the vehicle.

5. The vehicle sales system according to claim 3, wherein
the second management device performs a process of displaying the screen further including a price of the vehicle corresponding to the second resale information acquired from the second database.

6. The vehicle sales system according to claim 3, wherein
the second management device acquires, from the second database, the second resale information of the vehicle that meets a search condition, and displays the second resale information on the screen, and
the search condition includes at least one of a condition regarding a vehicle component mounted on the vehicle, and a condition regarding the maintenance place for the vehicle.

7. The vehicle sales system according to claim 1, wherein
the first management device is the output device acquires, from the first database, the first resale information of the vehicle that has been returned to the OEM upon expiration of a lease period of the vehicle and that meets a search condition inputted by an intermediary for the vehicle, and performs, as the output process, a process of displaying a screen including the first resale information having been acquired, to the intermediary.

8. The vehicle sales system according to claim 7, wherein
the screen includes at least one of pieces of information regarding the manufacturers of the vehicle components, wear statuses of the vehicle components, and the maintenance place for the vehicle.

9. The vehicle sales system according to claim 7, wherein
the search condition includes at least one of a condition regarding a vehicle component mounted on the vehicle, and a condition regarding the maintenance place for the vehicle.

10.-11. (canceled)

12. The vehicle sales system according to claim 1, wherein
the first management device receives the vehicle information from the vehicle, registers the vehicle information into a third database, generates, based on the vehicle information in the third database, the first resale information being at least one of a component ID of a vehicle component other than a genuine article, and the number of times of use of an unauthorized maintenance shop, and registers the first resale information into the first database.

13. An in-vehicle device comprising a processor programmed to perform operations comprising:
acquiring vehicle information including at least one of a list of vehicle components mounted on a vehicle, manufacturers of the vehicle components, a maintenance place for the vehicle, and use histories of the vehicle components; and
transmitting the vehicle information acquired, to a management device used by an OEM (Original Equipment Manufacturer).

14. The in-vehicle device according to claim 13, wherein
the vehicle information further includes internal vehicle information exchanged inside the vehicle and data occurrence time, and
the internal vehicle information is driving control information of the vehicle.

15. A vehicle-sales management method performed in a vehicle sales system including a first management device used by an OEM (Original Equipment Manufacturer), the vehicle-sales management method comprising:
a step of receiving, performed by the first management device, from a vehicle, vehicle information including at least one of a list of vehicle components mounted on the vehicle, manufacturers of the vehicle components, a maintenance place for the vehicle, and use histories of the vehicle components;
a step of registering, performed by the first management device, into a first database, first resale information generated based on the vehicle information having been received; and
a step of acquiring, from the first database, the first resale information corresponding to the vehicle, and of performing an output process based on the first resale information having been acquired.

16. The vehicle sales system according to claim 4, wherein
the second management device performs a process of displaying the screen further including a price of the vehicle corresponding to the second resale information acquired from the second database.

17. The vehicle sales system according to claim 4, wherein
the second management device acquires, from the second database, the second resale information of the vehicle that meets a search condition, and displays the second resale information on the screen, and
the search condition includes at least one of a condition regarding a vehicle component mounted on the vehicle, and a condition regarding the maintenance place for the vehicle.

18. The vehicle sales system according to claim 5, wherein
the second management device acquires, from the second database, the second resale information of the vehicle that meets a search condition, and displays the second resale information on the screen, and
the search condition includes at least one of a condition regarding a vehicle component mounted on the vehicle, and a condition regarding the maintenance place for the vehicle.

19. The vehicle sales system according to claim 8, wherein
the search condition includes at least one of a condition regarding a vehicle component mounted on the vehicle, and a condition regarding the maintenance place for the vehicle.

20. The vehicle sales system according to claim 2, wherein
the first management device receives the vehicle information from the vehicle, registers the vehicle information into a third database, generates, based on the vehicle information in the third database, the first resale information being at least one of a component ID of a vehicle component other than a genuine article, and the number of times of use of an unauthorized maintenance shop, and registers the first resale information into the first database.

21. The vehicle sales system according to claim 3, wherein
the first management device receives the vehicle information from the vehicle, registers the vehicle information into a third database, generates, based on the vehicle information in the third database, the first resale information being at least one of a component ID of a vehicle component other than a genuine article, and the number of times of use of an unauthorized maintenance shop, and registers the first resale information into the first database.

22. The vehicle sales system according to claim 4, wherein
the first management device receives the vehicle information from the vehicle, registers the vehicle information into a third database, generates, based on the vehicle information in the third database, the first resale information being at least one of a component ID of a vehicle component other than a genuine article, and the number of times of use of an unauthorized maintenance shop, and registers the first resale information into the first database.
